(19) United States
(12) Patent Application Publication
(10) Pub. No.: US 2019/0358945 A1
(43) Pub. Date: Nov. 28, 2019

(54) FILM APPLYING APPARATUS

(71) Applicant: Sharp Kabushiki Kaisha, Sakai-City, Osaka (JP)

(72) Inventor: Tadashi NISHIOKA, Sakai City (JP)

(21) Appl. No.: 15/761,445

(22) PCT Filed: Mar. 16, 2017
(86) PCT No.: PCT/JP2017/010636

§ 371 Date: Mar. 20, 2018

(51) Int. Cl. B32B 37/00; B32B 37/10

(52) U.S. Cl. CPC B32B 37/0053; B32B 37/1036; B32B 37/003

(57) ABSTRACT

A film applying apparatus includes a stage configured to receive a cover glass on the stage, the cover glass having curved portions at opposite ends of the cover glass, and a pressing member positioned in transverse to the cover glass. The pressing member includes a curved plane portion having a curvature radius less than a curvature radius of the curved portion, and a bend preventing portion with a cross section configured to prevent bending of the curved plane portion.

### TECHNICAL FIELD

The disclosure relates to a film applying apparatus configured to apply a film such as an Electroluminescence (EL) device, including an EL element, to a cover glass. The disclosure also relates to an EL device manufacturing apparatus, an EL device manufacturing method, and a controller of the apparatus.

### BACKGROUND ART

A configuration has been known in which when a second display panel is applied to a first display subpanel for producing a curved laminated display panel, a pressing roller is rolled on the second display panel from one end to the other end while holding the second display panel in a bending state with the second display panel being convex toward the first display subpanel (PTL1).

### CITATION LIST

### Patent Literature

PTL 1: JP 2002-341323 A (published Nov. 27, 2002).

### SUMMARY

### Technical Problem

Recently, there has been an increasing demand for a display panel in which opposite ends of the display panel are curved, such as a display panel in which a flexible EL device is disposed. In such a display panel, it is required to apply a sheet of a film, on which the EL device is disposed, onto a cover glass that includes opposite curved ends. For this reason, a pressing roller configured to press the film onto the cover glass is positioned in transverse to the cover glass. In this case, it is necessary to make the radius of curvature of the pressing roller less than the radius of curvature of the opposite curved ends of the cover glass in order to provide a good application of the film to the opposite curved ends of the cover glass.

However, the less the curvature radius of the pressing roller, the thinner the pressing roller positioned transverse the cover glass. Thus, due to the reaction force from the film pressed onto the cover glass, the pressing roller is bent in a direction away from the cover glass. As a result, air bubbles may be formed in a gap between the film and the cover glass.

### Solution to Problem

A film applying apparatus according to one aspect of the disclosure includes a stage configured to receive a cover glass on the stage, the cover glass having curved portions at opposite ends of the cover glass, the curved portions being curved relative to one surface of the cover glass, and a pressing member positioned in transverse to the cover glass and configured to apply the film to the one surface of the cover glass received on the stage, wherein the pressing member includes a curved plane portion having a curvature radius less than a curvature radius of the curved portions and configured to press the film against the curved portions of the cover glass, and a bend preventing portion with a cross section configured to prevent bending of the curved plane portion along a transverse direction of the pressing member.

### Advantageous Effects of Disclosure

According to one embodiment of the disclosure, it is possible to apply a film to a cover glass in which opposite ends of the cover glass are curved while to provide a good seal.

### BRIEF DESCRIPTION OF DRAWINGS

FIG. 1A is a perspective view schematically illustrating a configuration of a film applying apparatus according to a comparative example.

FIG. 1B is a perspective view illustrating a film to be applied by the film applying apparatus.

FIG. 1C is a perspective view illustrating a cover glass with the film having been applied.

FIG. 1D is a perspective view illustrating the cover glass.

FIG. 2A is a diagram illustrating a relationship between an applying roller provided in the film applying apparatus and a cover glass.

FIG. 2B is a diagram illustrating a relationship between a curved portion of the cover glass and the applying roller.

FIG. 2C is a diagram illustrating a relationship between the end of the curved portion and the applying roller.

FIG. 3A is a transverse cross-sectional view of an Organic Light Emitting Diode (OLED) flat surface film to be applied to the cover glass and the applying roller.

FIG. 3B is a sectional view of the applying roller and a reinforcing roller as viewed in a direction perpendicular to the transverse direction.

FIG. 4A is a perspective view schematically illustrating the applying roller and the reinforcing roller.

FIG. 4B is a perspective view illustrating the applying roller and the reinforcing roller as the actual dimensions of the rollers are approximate when viewed in the transverse direction.

FIG. 5 is a diagram schematically illustrating a configuration of a film applying apparatus according to another comparative example.

FIG. 6 is a perspective view schematically illustrating a configuration of a film applying apparatus according to a first embodiment.

FIG. 7A is a perspective view illustrating the pressing member provided in the film applying apparatus.

FIG. 7B is a front view illustrating the pressing member and a cover glass.

FIG. 8A is a perspective view illustrating a pressing member according to a second embodiment provided in the film applying apparatus.

FIG. 8B is a front view illustrating the pressing member and a cover glass.

FIG. 9A is a perspective view illustrating a pressing member according to a third embodiment provided in the film applying apparatus.

FIG. 9B is a front view illustrating the pressing member and a cover glass.

FIG. 10A is a perspective view illustrating a pressing member provided in a film applying apparatus according to a fourth embodiment.

FIG. 10B is a front view illustrating the pressing member and a cover glass.

FIG. 11A is a perspective view illustrating a pressing member according to a fifth embodiment provided in a film applying apparatus.

FIG. 11B is a front view illustrating the pressing member and a cover glass.

FIG. 12A is a perspective view illustrating a pressing member provided in the film applying apparatus according to a sixth embodiment.

FIG. 12B is a front view illustrating the pressing member and a cover glass.

### DESCRIPTION OF EMBODIMENTS

### Premise of Embodiments

First, premise of embodiments will be described.

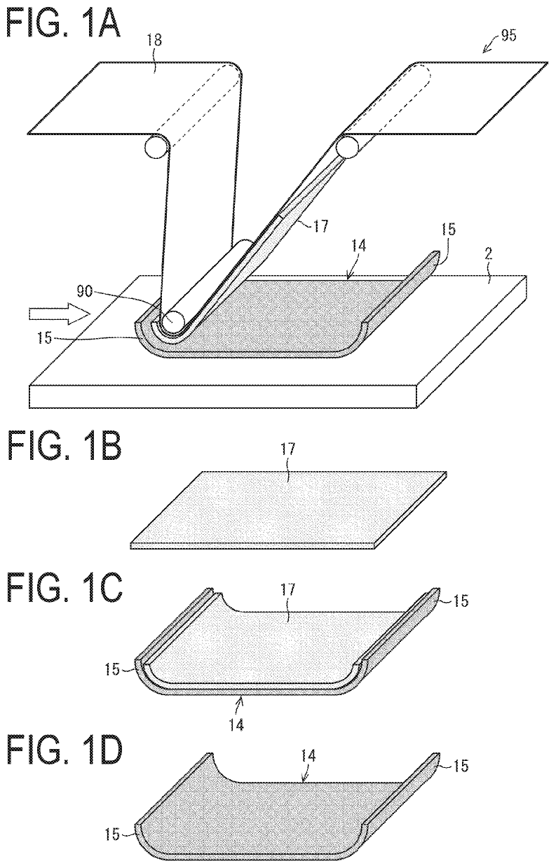

FIG. 1A is a perspective view schematically illustrating a configuration of a film applying apparatus 95 according to a comparative example. FIG. 1B is a perspective view illustrating onto which a film 17 is applied by the film applying apparatus 95. FIG. 1C is a perspective view illustrating a cover glass 14 onto which the film 17 having been applied. And FIG. 1D is a perspective view illustrating the cover glass 14.

The film applying apparatus 95 includes a stage 2 (Cover Glass (CG) positioning stage) configured to receive a cover glass 14 on the stage 2. The cover glass 14 has curved portions 15 that have been curved relative to one surface of the glass at the opposite ends of the glass. A film 17 (an Organic Light Emitting Diode (OLED) flat surface film) carried on a transfer sheet 18 is fed onto the cover glass 14 by a feeding roller.

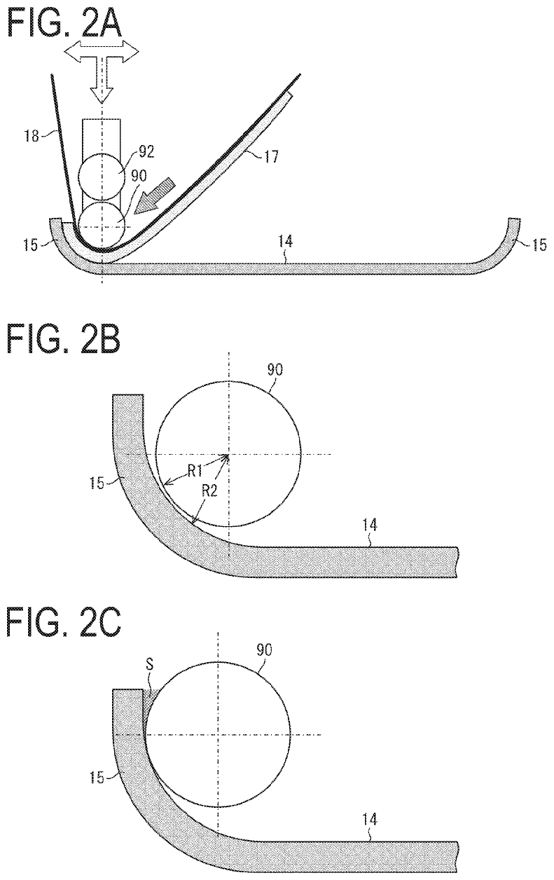

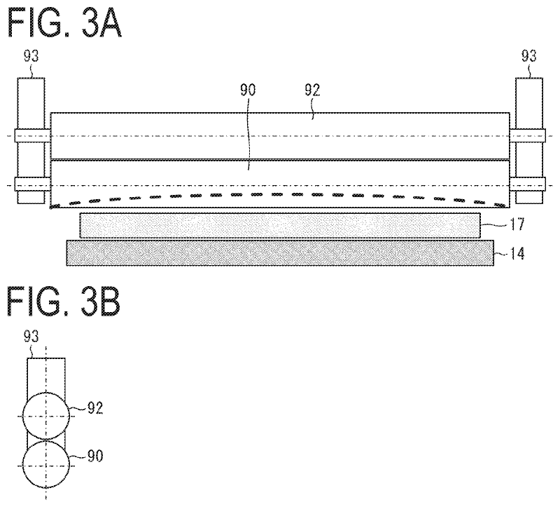

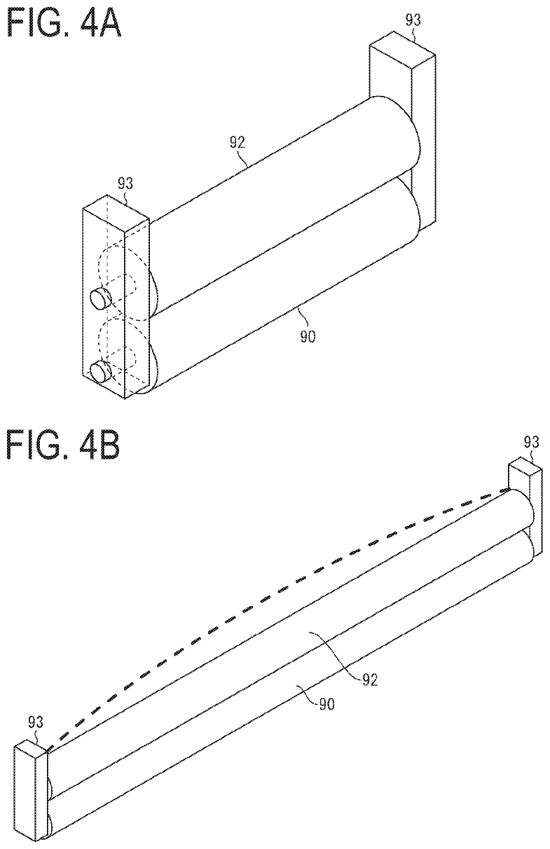

FIG. 2A is a diagram illustrating a relationship between an applying roller 90 provided in the film applying apparatus 95 and a cover glass 14. FIG. 2B is a diagram illustrating a relationship between a curved portion 15 of the cover glass 14 and the applying roller 90. FIG. 2C is a diagram illustrating a relationship between the end of the curved portion 15 and the applying roller 90. FIG. 3A is a transverse cross-sectional view of a film 17 to be applied to the cover glass 14 and the applying roller 90. FIG. 3B is a sectional view of the applying roller 90 and a reinforcing roller 92 as viewed in a direction perpendicular to the transverse direction. FIG. 4A is a perspective view schematically illustrating the applying roller 90 and the reinforcing roller 92. And FIG. 4B is a perspective view illustrating the applying roller 90 and the reinforcing roller 92 as the actual dimensions of the rollers are approximate when viewed in the transverse direction.

The film applying apparatus 95 includes the applying roller 90 and the reinforcing roller 92 positioned in transverse to the cover glass 14, and a pair of supporting members 93 configured to support the applying roller 90 and the reinforcing roller 92 on both sides of the supporting members 93. The reinforcing roller 92 is provided and configured to reinforce the rigidity of the applying roller 90. The applying roller 90 is made of SUS or resin, has a diameter, for example, of 5 mm, and has a curvature radius R1 less than the curvature radius R2 of the curved portion 15 of the cover glass 14.

The applying roller 90 is positioned in transverse to the cover glass 14 and rotates while moving along one surface of the cover glass 14. The applying roller 90 presses the film 17 from above the transfer sheet 18 toward the cover glass 14 and applies the film 17 to the cover glass 14.

The curvature radius R1 of the applying roller 90 is less than the curvature radius R2 of the curved portion 15 of the cover glass 14, so that it is also possible to apply the film 17 to the curved portion 15 with a good seal by pressing the film 17 against the cover glass 14 while moving the applying roller 90 along one surface of the cover press 14.

It is required that the region in which the applying roller 90 presses the film 17 against the cover glass 14 is not a planar region but a linear region. Therefore, the cross section of the pressing member needs to be circular or the like as in the applying roller 90 so that a space S for relief is formed between the applying roller 90 and the cover glass 14.

However, as the film 17 and the cover glass 14 increase in transverse size, the length of the applying roller 90 needs to be longer, for example, about 500 mm or greater. In a case where the bending size (curvature radius R2) of the curved portion 15 of the cover glass 14 is small, the curvature radius R1 of the applying roller 90 also needs to be small. As a result, the applying roller 90 becomes thin.

When the applying roller 90 is elongated as described above, the reaction force from the film 17 that has been pressed against the cover glass 14 bends the applying roller 90 in a direction away from the cover glass 14 as illustrated in FIG. 3A, Thus, there is a problem that a gap may be formed between the film 17 and the cover glass 14 to form air bubbles.

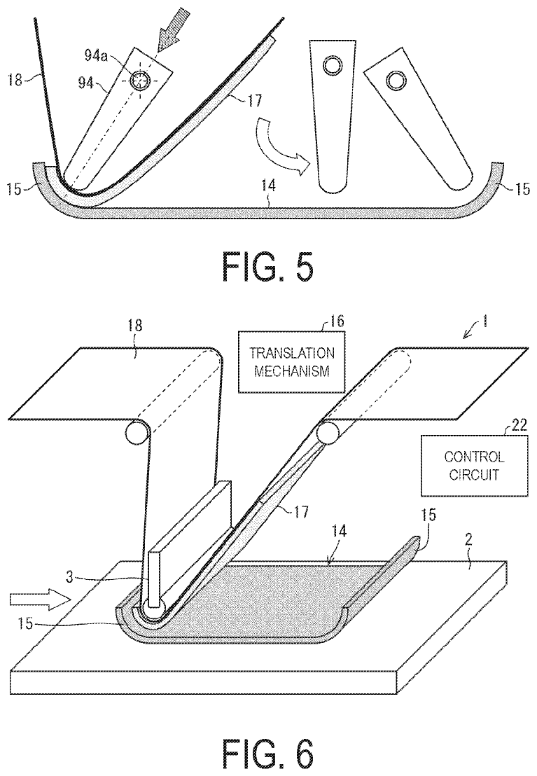

FIG. 5 is a diagram schematically illustrating a configuration of a film applying apparatus according to the comparative example. This film applying apparatus includes a flat squeegee 94 with a rounded edge. The squeegee 94 is configured to be pivotable around a shaft 94a which is provided on the proximal end side of the squeegee. When the squeegee 94 pivots around the shaft 94a while moving along a path corresponding to the surface of the cover glass 14, the edge of the squeegee 94 presses the film 17 in the linear region toward the cover glass 14.

However, there is a problem that setting the path on which squeegee 94 that is configured to press the film 17 to the cover glass 14 with a pivoting mechanism is moved in the linear region, may become complicated.

### First Embodiment

FIG. 6 is a perspective view schematically illustrating a configuration of a film applying apparatus according to a first embodiment. The film applying apparatus 1 includes a stage 2 (CG positioning stage) configured to receive a cover glass (CG) 14 on the stage 2. The cover glass 14 has curved portions 15 at opposite ends of the cover glass 14, the curved portions 15 being curved relative to one surface of the cover glass 14. A film 17 carried on a transfer sheet 18 is fed onto the cover glass 14 by a feeding roller. The film applying apparatus 1 is provided with a pressing member 3 positioned in transverse to the cover glass 14 and configured to apply the film (an OLED flat surface film) 17 to the one surface of the cover glass 14 on the stage 2. On the film 17, an EL element is formed.

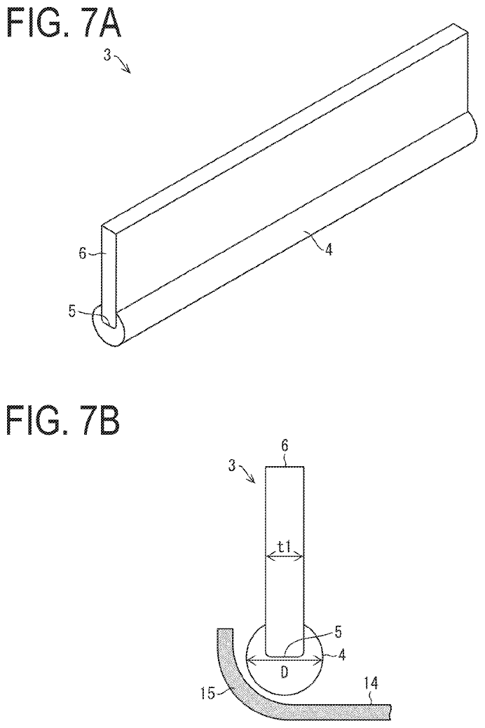

FIG. 7A is a perspective view illustrating the pressing member 3 provided in the film applying apparatus 1. FIG. 7B is a front view illustrating the pressing member 3 and the cover glass 14. The pressing member 3 includes a cylindrical portion 4 (a curved plane portion) configured to press the film 17 against the curved portion 15 of the cover glass 14. The cylindrical portion 4 has a cross section that a curvature radius of the section is less than a curvature radius of the curved portion 15. A groove 5 is formed in the peripheral surface of the cylindrical portion 4 along the direction of the central axis. The pressing member 3 further includes a flat plate 6 (a bend preventing portion) configured to prevent the cylindrical portion 4, that is extending along the transverse direction of the pressing member 3, from bending. The flat plate 6 is fitted into the groove 5. From a viewpoint of more effectively preventing the bending mentioned above of the cylindrical portion 4, it is preferable that the thickness t1 of the flat plate 6 be one half of the diameter D or greater of the cylindrical portion 4.

The film applying apparatus 1 further includes a translation mechanism 16 configured to translate the cylindrical portion 4 of the pressing member 3 along one surface of the cover glass 14. The film applying apparatus 1 is provided with a control circuit 22 (a controller) configured to control the translation mechanism 16 to translate the cylindrical portion 4 of the pressing member 3 along one surface of the cover glass 14.

Thus, regarding to the pressing member 3 according to the first embodiment, the flat plate 6, having a cross section elongated along in the depth direction of the groove 5, is fitted in the groove 5 formed along the central axis of the cylindrical portion 4. This also eliminates a bending at the central portion of the cylindrical portion 4 extending along the transverse direction of the pressing member 3. Thus, it is possible to apply a pressure to the film 17 toward the cover glass 14 via the transfer sheet 18 entirely across the linear region in the transfer sheet 18 contacted by the cylindrical portion 4, from one end to the other end. As a result, the possibility of forming a gap between the film 17 and the cover glass 14 and air bubbles is eliminated. In this way, good EL devices can be produced.

Furthermore, the translation mechanism 16 applies the film 17 to the cover glass 14 by sliding the cylindrical portion 4 of the pressing member 3 on a side of the transfer sheet 18 opposite the cover glass 13 without rotating the cylindrical portion 4. Thus, a rotating mechanism such as the squeegee 94 described above referring to FIG. 5 is not necessary, and the configuration of the film applying apparatus 1 is simplified.

It is preferable that am EL element is formed on the film 17. The EL element may be an OLED, an inorganic light emitting diode or a quantum dot light emitting diode. This also applies to the embodiments described later.

### Second Embodiment

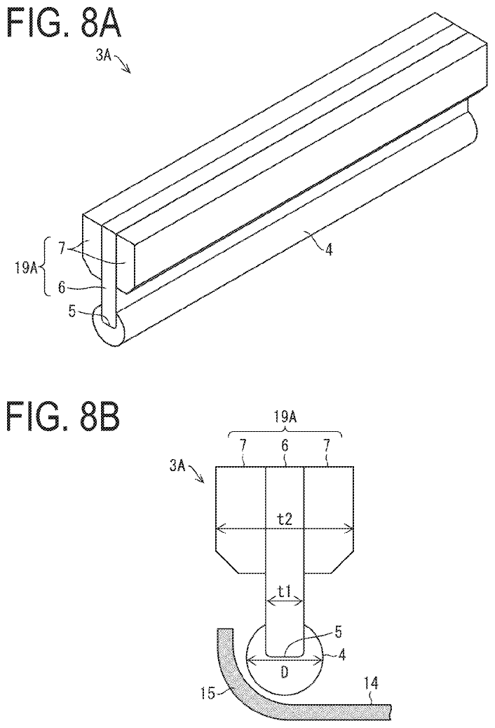

FIG. 8A is a perspective view illustrating a pressing member 3A according to a second embodiment provided in the film applying apparatus. FIG. 8B is a front view illustrating the pressing member 3A and a cover glass 14. Components similar to those described above are designated by the same reference numerals. Such components are not described in detail again here. This also applies to the embodiments described later.

The pressing member 3A includes a plate portion 19A (a bend preventing portion). The plate portion 19A is provided with a flat plate 6 and a pair of reinforcing plates 7 (bend preventing portions) provided on both sides of the flat plate 6 to reinforce the rigidity of the flat plate 6. From a viewpoint of more effectively preventing a bending of the cylindrical portion 4, it is preferable that the thickness t1 of the flat plate 6 be one half of the diameter D or greater of the cylindrical portion 4. From a viewpoint of more effectively preventing warpage of the flat plate 6, it is preferable that a dimension t2 obtained by adding the total thickness of the pair of the reinforcing plates 7 of the plate portion 19A and the thickness t1 of the flat plate 6 be four times or greater than the thickness t1 of the flat plate 6.

In this way, the pair of reinforcing plates 7 provided on the opposite side of the flat plate 6 prevents warpage of the flat plate 6. As a result, according to the second embodiment, in addition to the advantageous effect of the first embodiment that a pressure can be applied to the film 17 entirely across the linear region in the transfer sheet 18 contacted by the cylindrical portion 4, from one end to the other end, another advantageous effect is produced that warpage of the flat plate 6 is prevented, so that the shape of the linear region in the transfer sheet 18 contacted by the cylindrical portion 4 is more linear. Therefore, it is possible to make more linear the shape of the region in the film 17 to which the cylindrical portion 4 applies a pressure.

### Third Embodiment

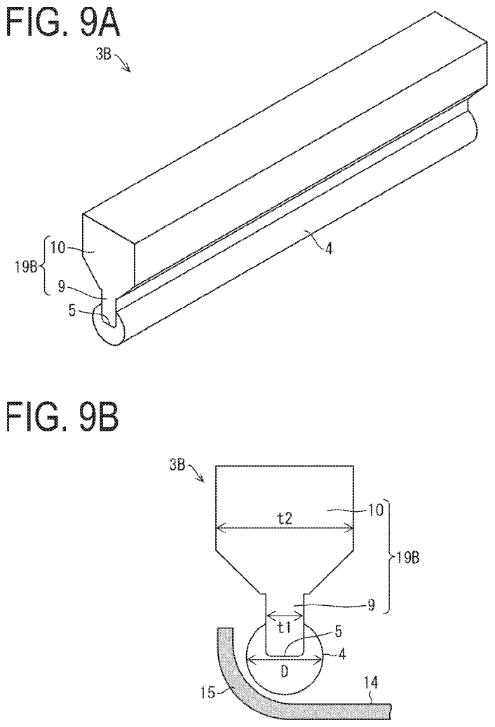

FIG. 9A is a perspective view illustrating a pressing member 3B according to a third embodiment provided in the film applying apparatus. FIG. 9B is a front view illustrating the pressing member 3B and a cover glass 14.

The pressing member 3B includes a plate portion 19B (a bend preventing portion). The plate portion 19B includes an insertion portion 9 (a bend preventing portion) inserted in a groove 5 of the cylindrical portion 4, and a rigid portion 10 (a bend preventing portion) formed to be thicker than the thickness of the insertion portion 9 and configured to reinforce the rigidity of the insertion portion 9. From a viewpoint of more effectively preventing bending of the cylindrical portion 4, it is preferable that the thickness t1 of the insertion portion 9 be one half of the diameter D or greater of the cylindrical portion 4. From a viewpoint of more effectively preventing warpage of the insertion portion 9, it is preferable that the thickness t2 of the rigid portion 10 be four times or greater than the thickness t1 of the insertion portion 9.

In this way, the groove 5 is formed in the cylindrical portion 4, and the plate portion 19B having a rigid shape is fitted in the groove 5, so that bending at the central portion of the cylindrical portion 4 is also eliminated, and a pressure can be applied to the film 17 entirely across the linear region in the transfer sheet 18 contacted by the cylindrical portion 4, from one end to the other end, as in the first and second embodiments. Furthermore, as in the second embodiment, the shape of the linear region in the transfer sheet 18 contacted by the cylindrical portion 4 is more linear.

### Fourth Embodiment

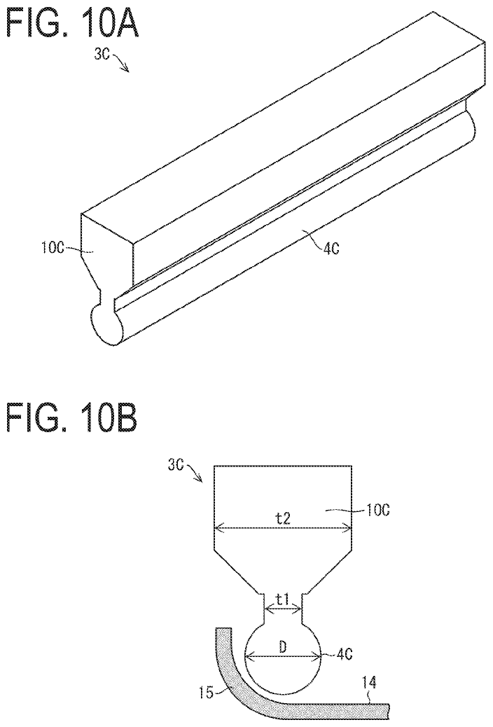

FIG. 10A is a perspective view illustrating a pressing member 3C according to a fourth embodiment provided in the film applying apparatus. FIG. 10B is a front view illustrating the pressing member 3C and a cover glass 14.

The pressing member 3C includes a cylindrical portion 4C and a rigid portion 10C. The cylindrical portion 4C and the rigid portion 10C are integrally formed. The cylindrical portion 4C corresponds to the cylindrical portion 4 of the third embodiment, and the rigid portion 10C corresponds to the plate portion 19B of the third embodiment. From a viewpoint of more effectively preventing bending of the cylindrical portion 4C, it is preferable that the thickness t1 of the rigid portion 10C at the lower part be one half of the diameter D or greater of the cylindrical portion 4C. From a viewpoint of more effectively preventing warpage of the lower part of the rigid portion 10C, it is preferable that the thickness t2 of the upper part of the rigid portion 10C be four times or greater than the thickness t1 of the lower part of the rigid portion 10C.

In this way, as in the first to third embodiments, the cylindrical portion 4C and the rigid portion 10C are integrally formed, so that bending at the central portion of the cylindrical portion 4 is also eliminated, and a pressure can be applied to the film 17 entirely across the linear region in the transfer sheet 18 contacted by the cylindrical portion 4, from one end to the other end. Furthermore, as in the second and third embodiments, the shape of the linear region in the transfer sheet 18 contacted by the cylindrical portion 4 is more linear.

### Fifth Embodiment

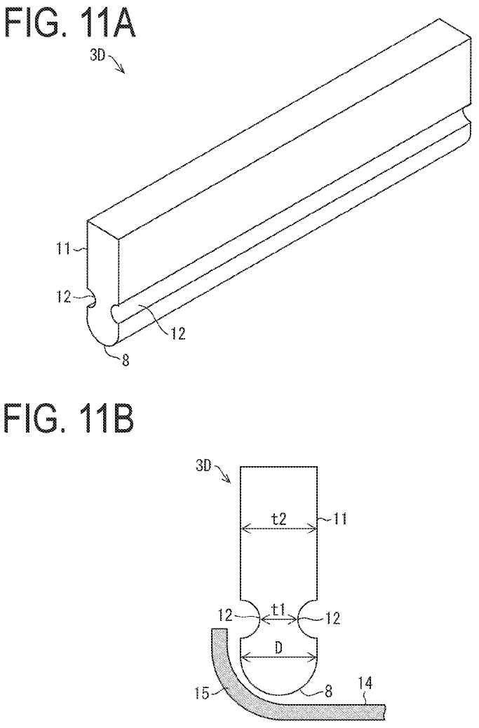

FIG. 11A is a perspective view illustrating a pressing member 3D according to a fourth embodiment provided in the film applying apparatus, and FIG. 11B is a front view illustrating the pressing member 3D and a cover glass 14.

The pressing member 3D includes a semicircular portion 8 (curved plane portion) having a central axis along the transverse direction of the pressing member 3D and having a semicircular cross section, and a plate portion 11 (a bend preventing portion) formed integrally with the semicircular portion 8. Furthermore, relief grooves 12 are formed between the semicircular portion 8 and the plate portion 11. From a viewpoint of more effectively preventing bending of the semicircular portion 8, it is preferable that the thickness t1 at a part, in which the relief grooves 12 are formed, be one half of the diameter D or greater of the semicircular portion 8. From a viewpoint of more effectively preventing warpage at a part in which the relief grooves 12 are formed, it is preferable that the thickness t2 of the plate portion 11 be two times or greater than the thickness t1 at the part in which the relief grooves 12 are formed.

In this way, the semicircular portion 8 is formed at a distal end of pressing member 3, and the plate portion 11 is formed at a proximal end of the pressing member 3, so that bending at the central portion of the semicircular portion 8 is also eliminated, and a pressure can be applied to the film 17 entirely across the linear region in the transfer sheet 18 contacted by the semicircular portion 8, from one end to the other end, as in the first to fourth embodiments. Furthermore, as in the second to fourth embodiments, the shape of the linear region in the transfer sheet 18 contacted by the semicircular portion 8 is more linear.

Furthermore, the relief grooves 12 are formed on both side of plate portion 11, the region that the semicircular portion 8 presses the film 17 against the curved portion 15 of the cover glass 14 is a linear region in place of a planer region.

### Sixth Embodiment

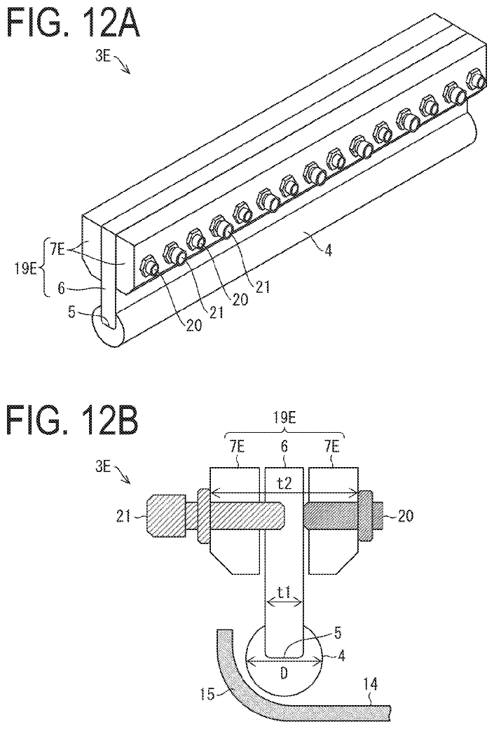

FIG. 12A is a perspective view illustrating a pressing member 3E according to a sixth embodiment provided in the film applying apparatus, and FIG. 12B is a front view illustrating the pressing member 3E and a cover glass 14.

The pressing member 3E includes a plate portion 19E (a bend preventing portion) as in the configuration illustrated in FIGS. 8A and 8B. The plate portion 19E is provided with a flat plate 6 and a pair of reinforcing plates 7E provided on both sides of the flat plate 6 to reinforce the rigidity of the flat plate 6. Furthermore, a set screw 20 (a warpage correction member) and a drawing thread 21 (a warpage correction member) for correcting warpage in the transverse direction of the flat plate 6 are provided at the reinforcing plates 7E. From a viewpoint of more effectively preventing a bending of the cylindrical portion 4, it is preferable that the thickness t1 of the flat plate 6 be one half of the diameter D or greater of the cylindrical portion 4. From a viewpoint of more effectively preventing warpage of the flat plate 6, it is preferable that a dimension t2 obtained by adding the total thickness of the pair of the reinforcing plates 7E of the plate portion 19E and the thickness t1 of the flat plate 6 be four times or greater than the thickness t1 of the flat plate 6.

Furthermore, a groove 5 is formed in the cylindrical portion 4, and the flat plate 6 is fitted in the groove 5, so that bending at the central portion of the cylindrical portion 4 is also eliminated, and a pressure can be applied to the film 17 entirely across the linear region in the transfer sheet 18 contacted by the cylindrical portion 4, from one end to the other end, as in the first to fifth embodiments.

Furthermore, the reinforcing plates 7E are provided on both sides of the flat plate 6 and configured to prevent warpage of the flat plate 6, and the set screw 20 and the drawing thread 21 correct warpage of the flat plate 6, so that the shape of the linear region in the transfer sheet 18 contacted by the cylindrical portion 4 is more linear.

### Supplement

A film applying apparatus according to a first aspect includes a stage configured to receive a cover glass on the state, the cover glass having curved portions at opposite ends of the cover glass, the curved portions being curved relative to one surface of the cover glass, and a pressing member positioned in transverse to the cover glass and configured to apply the film to the one surface of the cover glass received on the stage, wherein the pressing member includes: a curved plane portion having a curvature radius less than a curvature radius of the curved portions and configured to press the film against the curved portions of the cover glass; and a bend preventing portion with a cross section configured to prevent bending of the curved plane portion along a transverse direction of the pressing member.

According to a second aspect, the film applying apparatus further includes a translation mechanism configured to translate the curved plane portion along the one surface of the cover glass.

According to a third aspect, the curved plane portion includes a cylindrical portion having a central axis along the transverse direction, a groove is formed in a peripheral surface of the cylindrical portion along the transverse direction, and the bend preventing portion includes a plate portion fitted in the groove.

According to the fourth aspect, the plate portion includes a flat plate inserted into the groove, and a pair of reinforcing plates provided on both sides of the flat plate and configured to reinforce rigidity of the flat plate.

According to the fifth aspect, the plate portion includes an insertion portion to be inserted into the groove, and a rigid portion formed to be thicker than a thickness of the insertion portion and configured to reinforce rigidity of the insertion portion.

According to a sixth aspect, the cylindrical portion and the plate portion are integrally formed.

According to a seventh aspect, the curved plane portion includes a semicircular portion having a central axis along the transverse direction and having a semicircular cross section, the bend preventing portion includes a plate portion formed integrally with the semicircular portion, and relief grooves are formed between the semicircular portion and the plate portion.

According to an eighth aspect, warpage correction members configured to correct warpage of the flat plate along the transverse direction of the flat plate are provided in the reinforcing plates.

According to a ninth aspect, an EL device is formed on the film.

An EL device manufacturing apparatus according to tenth aspect includes a stage configured to receive a cover glass on the stage, the cover glass having curved portions at opposite ends of the cover glass, the curved portions being curved relative to one surface of the cover glass, and a pressing member positioned in transverse to the cover glass and configured to apply the film to the one surface of the cover glass received on the stage, wherein an EL element is formed on the film, and the pressing member includes a curved plane portion having a curvature radius less than a curvature radius of the curved portions and configured to press the film against the curved plane portion of the cover glass, and a bend preventing portion with a cross section configured to prevent bending of the curved plane portion along a transverse direction of the pressing member.

An EL device manufacturing method according to eleventh aspect includes receiving a cover glass on a stage, the cover glass having curved portions at opposite ends of the cover glass, the curved portions being curved relative to one surface of the cover glass, and applying a film to the one surface of the cover glass received on the stage by a pressing member positioned in transverse to the cover glass, wherein an EL element is formed on the film, and the pressing member includes a curved plane portion having a curvature radius less than a curvature radius of the curved portions and configured to press the film against the curved plane portion of the cover glass; and a bend preventing portion with a cross section configured to prevent bending of the curved plane portion along a transverse direction of the pressing member.

According to a twelve aspect, the applying the film to the one surface of the cover glass includes feeding the film attached on a transfer sheet to the one surface of the cover glass, and translating the curved plane portion such that the curved plane portion slides on a surface of the transfer sheet opposite the cover glass to apply the film to the one surface of the cover glass.

A controller according to a thirteen aspect is a controller configured to control the EL device manufacturing apparatus of the tenth aspect, wherein the EL device manufacturing apparatus further includes a translation mechanism configured to translate a curved plane portion along one surface of a cover glass, and the controller includes a control circuit configured to control the translation mechanism to translate the curved plane portion along the one surface of the cover glass.

The disclosure is not limited to each of the embodiments stated above, and various modifications may be implemented within a range not departing from the scope of the claims. Embodiments obtained by appropriately combining technical approaches stated in each of the different embodiments also fall within the scope of the technology of the disclosure. Moreover, novel technical features may be formed by combining the technical approaches stated in each of the embodiments.

### REFERENCE SIGNS LIST

1 Film applying apparatus
2 Stage (Cover Glass (CG) positioning stage)
3 Pressing member
4 Cylindrical portion (Curved plane portion)
5 Groove
6 Flat plate (Bend preventing portion)
7 Reinforcing plate (Bend preventing portion)
8 Semicircular portion (Curved plane portion)
9 Insertion portion (Bend preventing portion)
10 Rigid portion (Bend preventing portion)
11 Plate portion (Bend preventing portion)
12 Relief groove
16 Translation mechanism
17 Film
19A, 19B, 19C Plate portion (Bend preventing portion)
20 Set screw (Warpage correction member)
21 Drawing thread (Warpage correction member)
22 Control circuit

1-2. (canceled)

3: A film applying apparatus, comprising:
a stage configured to receive a cover glass on the stage, the cover glass having curved portions at opposite ends of the covered glass, the curved portions being curved relative to one surface of the cover glass, and
a pressing member positioned transverse the cover glass and configured to apply the film to the one surface of the cover glass received on the stage,
wherein the pressing member includes:
a curved plane portion having a curvature radius less than a curvature radius of the curved portions and configured to press the film against the curved portions of the cover glass, and
a bend preventing portion with a cross section configured to prevent bending of the curved plane portion along a transverse direction of the pressing member,
wherein the curved plane portion comprises a cylindrical portion having a central axis along the transverse direction,
a groove is formed in a peripheral surface of the cylindrical portion along the transverse direction, and
the bend preventing portion comprises a plate portion fitted in the groove.

4: The film applying apparatus according to claim 3,
wherein the plate portion comprises:
a flat plate inserted into the groove; and
a pair of reinforcing plates provided on both sides of the flat plate and configured to reinforce rigidity of the flat plate.

5: The film applying apparatus according to claim 3,
wherein the plate portion comprises:
an insertion portion to be inserted into the groove; and
a rigid portion formed to be thicker than a thickness of the insertion portion and configured to reinforce rigidity of the insertion portion.

6: The film applying apparatus according to claim 3,
wherein the cylindrical portion and the plate portion are integrally formed.

7: A film applying apparatus comprising:
a stage configured to receive a cover glass on the stage, the cover glass having curved portions at opposite ends of the cover glass, the curved portions being curved relative to one surface of the cover glass, and
a pressing member positioned in transverse to the cover glass and configured to apply the film to the one surface of the cover glass received on the stage,
wherein the pressing member includes:
a curved plane portion having a curvature radius less than a curvature radius of the curved portions and configured to press the film against the curved portions of the cover glass, and
a bend preventing portion with a cross section configured to prevent bending of the curved plane portion along a transverse direction of the pressing member,
wherein the curved plane portion comprises a semicircular portion having a central axis along the transverse direction and having a semicircular cross section,
the bend preventing portion comprises a plate portion formed integrally with the semicircular portion, and
relief grooves are formed between the semicircular portion and the plate portion.

8: The film applying apparatus according to claim 4, wherein warpage correction members configured to correct warpage of the flat plate along the transverse direction of the flat panel are provided in the reinforcing plates.

9-13. (canceled)

14: The film applying apparatus according to claim 3, further comprising a translation mechanism configured to translate the curved plane portion along the one surface of the cover glass.

15: The film applying apparatus according to claim 3,
wherein an EL element is formed on the film.

16: The film applying apparatus according to claim 7, further comprising a translation mechanism configured to translate the curved plane portion along the one surface of the cover glass.

17: The film applying apparatus according to claim 7,
wherein an EL element is formed on the film.
